(19) United States
(12) Patent Application Publication
(10) Pub. No.: US 2015/0354252 A1
(43) Pub. Date: Dec. 10, 2015

(54) AIRCRAFT LOCK

(71) Applicant: LISI AEROSPACE, Paris (FR)

(72) Inventors: Etienne Luneau, Segry (FR); Vincent DeFrance, Bourges (FR); Gregory LeGrand, Vignoux Sur Barangeon (FR)

(73) Assignee: LISI AEROSPACE, Paris (FR)

(21) Appl. No.: 14/653,678

(22) PCT Filed: Dec. 6, 2013
(86) PCT No.: PCT/FR2013/052986

§ 371 Date: Jun. 18, 2015

(30) Foreign Application Priority Data
Dec. 19, 2012 (FR) 1262350

(51) Int. Cl. E05B 79/10; E05B 85/24

(52) U.S. Cl. CPC E05B 79/10; E05B 85/243

(57) ABSTRACT

The invention relates to a lock (100) comprising: -two substantially planar walls (101) bearing a first pivot connection axle (102) and a second pivot connection axle (103), the first and second axles being substantially perpendicular to the planes; -a catch (108) able to pivot about the first axle, the catch comprising a hook (109) able to catch a strike wire; -a pawl (111) able to pivot about the second axle, the pawl comprising a tooth (112) able to engage with at least one notch (113, 114) formed on the catch, when the lock is in what is known as the closed position; -a control lever (115) able to pivot about the second axle, the lever comprising a means (116) of driving the rotation of the pawl (111) about the second axle, the control lever comprising means (118, 119) for securing the closure of the lock.

The present invention relates to a lock. More accurately, the present invention relates to a lock for a door of a vehicle, of an aircraft for example.

A lock is known from the prior art comprising a planar support bearing a first pivoting link axis about which a catch pivots, said catch comprising a hook wound around a keeper, and a second pivoting link axis about which pivot a pawl and a control lever driving the pawl rotationally, said pawl comprising a tooth that engages with a notch formed on the catch when the lock is in what is referred to as the closed position. A lock of this kind is described in document US 2004/0135378, for example.

However, with a lock of this kind it may be that in the event of an anomaly, where there are significant vibrations for example, the tooth of the pawl is unintentionally disengaged from the notch formed in the catch, thereby causing the keeper to be released by the hook and the lock therefore opened. A situation of this kind is particularly dangerous, especially if it takes place while an aircraft is in flight.

The object of the present invention is to alleviate this technical problem by proposing a means of securing a lock of this kind in the closed position.

More accurately, the object of the present invention is a lock comprising two substantially planar walls bearing a first pivoting link axis and a second pivoting link axis, the first and second axes being substantially perpendicular to the planes; a catch capable of pivoting about the first axis, said catch comprising a hook capable of catching a keeper; a pawl capable of pivoting about the second axis, said pawl comprising a tooth capable of engaging with at least one notch formed on the catch; a control lever capable of pivoting about the second axis, the lever comprising a means of driving the pawl rotationally about the second axis, the control lever and/or the pawl comprising means of securing the closure of the lock.

A lock of this kind has the advantage of securing engagement of the tooth of the pawl with the notch of the catch.

The means of securing preferably comprise a hook formed on the control lever and a lug disposed on the catch, substantially parallel to the first axis. More preferably, the hook cooperates with the lug when the lock is in the closed position. When the lock is in the closed position, the tooth of the pawl is engaged with a notch in the catch.

A lock of this kind has the advantage of securing the engagement of the tooth of the pawl with the notch in the catch without adding a new part to the lock, thereby optimizing the weight associated with incorporating a new function.

The control lever and the pawl are preferably situated between the planes of the walls.

This kind of arrangement of the control lever and the pawl has the advantage of limiting the space required by the lock and reducing friction about the second axis compared with a case in which the control lever and the pawl are disposed on either side of one of the planes of the walls, thereby inducing a torque about the second axis.

According to an embodiment of the invention, the means of driving the pawl rotationally is a shoulder capable of cooperating with at least one lug formed on the pawl.

According to another embodiment of the invention, the control lever and the pawl are configured as one piece.

The lock preferably comprises means of detecting a position of the pawl.

A lock of this kind moreover has the advantage of indicating to a user if the lock is properly closed and locked.

More preferably, the means of detecting the position of the pawl comprise a visual marking disposed at one end of the control lever. Alternatively, the lock may comprise an inductive sensor detecting the position of the control lever.

Moreover, the walls preferably bear a third axis and a fourth axis substantially parallel to the first axis, the lock being capable of being fixed to a panel by means of the first, the third and the fourth axis.

A lock of this kind has the advantages of having a small number of points for fixing to a panel.

The invention will be made easier to understand by reading the following description and examining the accompanying figures. Said figures are provided by way of example without limiting the invention. The figures show:

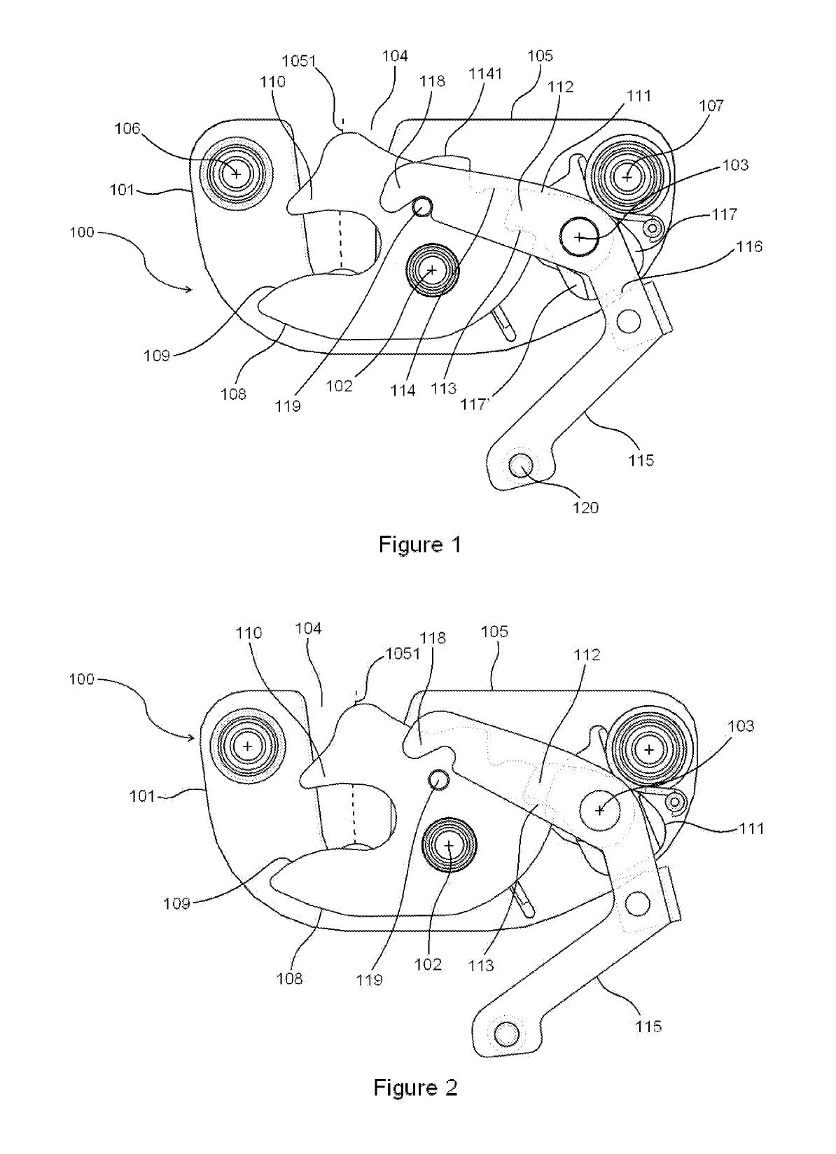

FIG. 1: a longitudinal sectional view through a lock according to an embodiment of the invention, in a closed and locked position;

FIG. 2: a longitudinal sectional view shown in FIG. 1, in a closed and unlocked position;

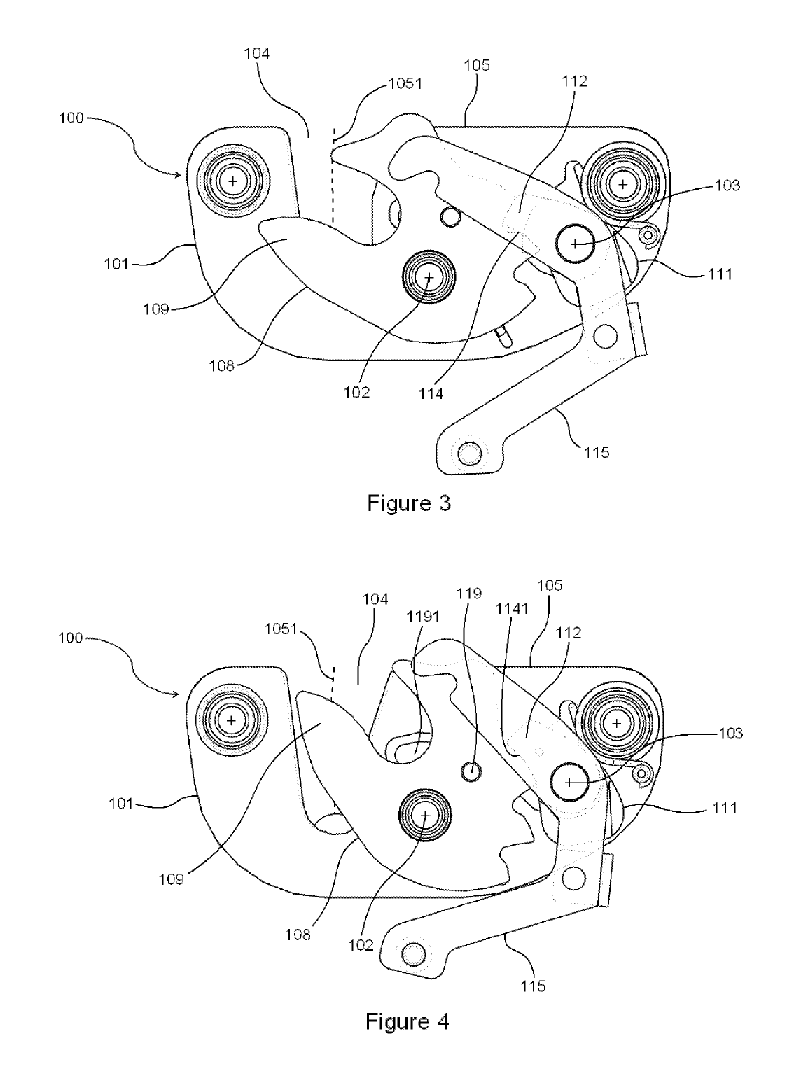

FIG. 3: a longitudinal sectional view of the lock shown in FIG. 1, in an intermediate position;

FIG. 4: a longitudinal sectional view of the lock shown in FIG. 1, in an open position;

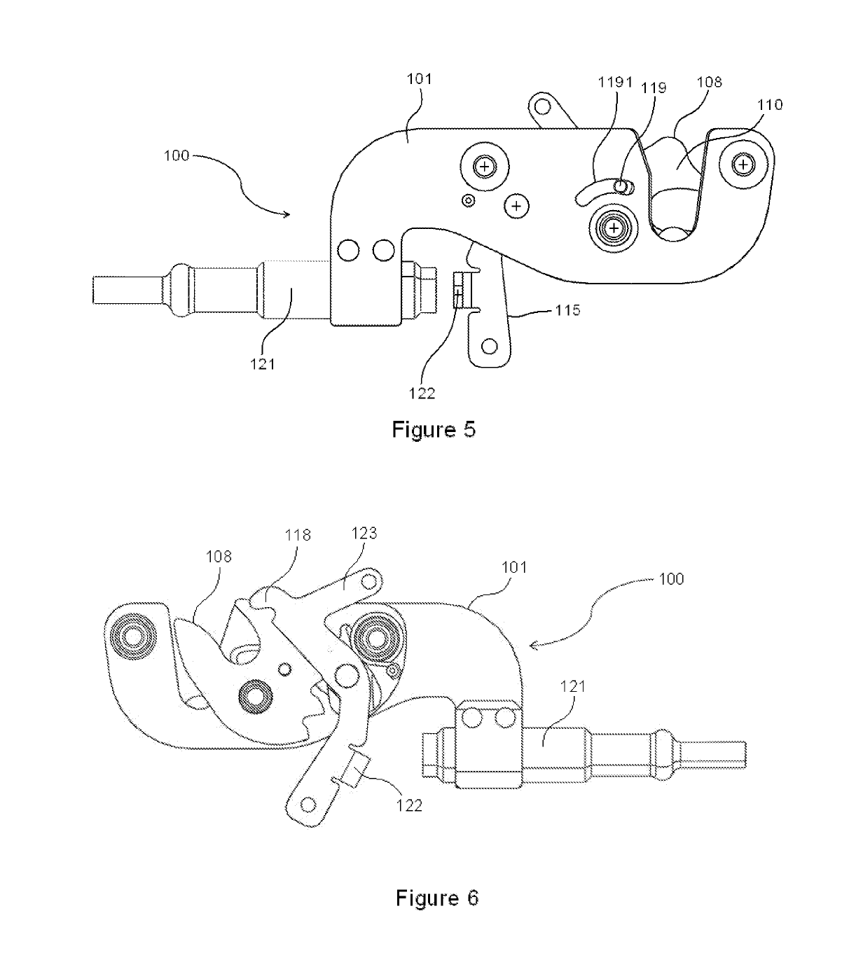

FIG. 5: a view of a side of a lock according to another embodiment, in a closed and locked position;

FIG. 6: a view of another side of the lock shown in FIG. 5, in an open position.

FIGS. 1 and 2 show a lock 100 according to an embodiment of the invention in what is referred to as a closed and locked position and a closed and unlocked position. In the following description “a closed position” of the lock 100 refers both to the closed and locked position and to the closed and unlocked position. The lock 100 is intended, for example, to be fixed on a swing or sliding door of a helicopter. In the example, the lock 100 is regarded as movable in relation to a structure of the helicopter.

The lock 100 comprises two walls 101 planar in form and substantially identical which are spaced according to a first pivoting link axis 102 and a second pivoting link axis 103. The first and second axes (102, 103) are substantially perpendicular to the planes of the walls 101. In FIGS. 1 to 6 only one of the walls 101 is visible as a result of the longitudinal section or the side view of the lock 100. The walls 101 comprise on their periphery an indentation forming an opening 104 in the form of a cone disposed according to an axis substantially perpendicular to the planes of the walls 101. The opening 104 emerges on the edges 105 of the walls 101.

The opening 104 is capable of receiving a striker plate (not shown) comprising a keeper disposed according to an axis substantially perpendicular to the planes of the walls 101. The striker plate is fixed to a structural part of a helicopter, for example. The keeper follows a path 1051 during the closing and opening of the door and of the lock 100, between the edges 105 of the walls 101 and the bottom of the opening 104.

Moreover, the walls 101 bear a third axis 106 and a fourth axis 107 which are substantially parallel to the first axis 102. Intersections between the first, third and fourth axes (102, 106, 107) and the plane of each of the walls 101 preferably form a triangle. This arrangement ensures that the lock 100 has good mechanical resistance when subjected to forces in the three spatial directions. The first, third and fourth axes (102, 106, 107) are capable of receiving means for fixing to a panel (not shown). In the example, the first, third and fourth axes (102, 106, 107) are each provided with a thread capable of cooperating with a screw.

The lock 100 likewise comprises a catch 108 capable of pivoting about the first axis 102. The catch 108 comprises a profile in the form of a hook 109 capable of being wound around the keeper when the keeper moves through the opening 104 according to the path 1051.

When the keeper follows the path 1051 from the bottom of the opening 104 to the edges 105, the catch 108 pivots in a first direction corresponding to what is referred to as an opening direction of the lock 100. When the keeper follows the path 1051 in the opposite direction, the catch 108 pivots in an opposite direction to the first direction, corresponding to what is referred to as a closing direction of the lock 100.

In the closed position a limb 110 of the hook 109 is disposed substantially perpendicularly to the path 1051 such as to lock the keeper in the opening 104.

In the example, the catch 108 is provided with a torsion spring tending to drive the catch 108 rotationally in the opening direction of the lock 100.

The lock 100 likewise comprises a pawl 111 capable of pivoting about the second axis 103. The pawl 111 comprises a tooth 112 capable of locking a rotation of the catch 108 in the opening direction of the lock 100.

The tooth 112 of the pawl 111 engages with a first notch 113 formed in the catch 108 when the lock 100 is in the closed position. The first notch 113 is formed on a periphery of the catch 108. When the tooth 112 is engaged with the first notch 113, the catch 108 is locked rotationally in the opening direction of the lock 100.

In the example, the tooth 112 of the pawl 111 likewise engages with a second notch 114 formed in the catch 108 when the lock is in what is referred to as an intermediate position. The lock 100 is depicted in the intermediate position in FIG. 3. The second notch 114 is formed on the periphery of the catch 108. The second notch 114 is disposed relative to the first notch 113, such that when the hook 109 follows the path 1051 from the bottom of the opening 104 to the edges 105 of the walls 101, the tooth 112 of the pawl 111 initially cooperates with the second notch 114, then with the first notch 113. When the tooth 112 is engaged with the second notch 114, the catch 108 is locked rotationally about the first axis 102, in the opening direction of the lock 100. This position guarantees minimum security in the event that the door should slam badly. The door is neither closed nor locked, but nevertheless it is not free to open simply under its own weight.

In the example, the tooth 112 of the pawl 111 likewise cooperates with a portion 1141 of the catch 108 when the lock 100 is in what is referred to as the open position. The lock 100 is represented in the open position in FIG. 4. The portion 1141 is disposed on the periphery of the catch 108. The portion 1141 of the catch 108 is disposed relative to the first and second notches (113, 114), such that when the keeper follows the path 1051 from the bottom of the opening 104 towards the edges 105, the tooth 112 of the pawl 111 initially cooperates with the portion 1141, then with the second notch 114 and finally with the first notch 113. When the tooth 112 cooperates with the portion 1141, the catch 108 is locked rotationally in the opening direction of the lock 100 by a point of contact between a lug 119 crossing the catch 108 substantially perpendicularly to the planes of the walls 101 and an oblong light 1191 formed in one of the walls 101. The oblong light 1191 is visible in FIG. 4 and in FIG. 5.

In the example, the pawl 111 is provided with a torsion spring tending to drive the pawl 111 rotationally in the closing direction of the lock 100. In other words, the torsion spring tends to drive the pawl 111 in such a manner as to ensure contact of the tooth 112 against the catch 108. Hence, when the catch 108 pivots in the closing direction of the lock 100, the tooth 112 of the pawl 111 slides successively on the portion 1141, the second notch 114, until it engages with the first notch 113.

The lock 100 comprises a control lever 115 capable of pivoting about the second axis 103.

The lever 115 comprises a means 116 for driving the pawl 111 rotationally about the second axis 103. In the example, the lever 115 and the pawl 111 are disposed between the planes of the walls 101. In the example, the means of driving the pawl 111 rotationally is a shoulder 116 capable of cooperating with two lugs (117, 117′) formed on the pawl 111 which limit the movement of the control lever 115 in the two opening and closing directions of the lock 100. According to a variant, the lever 115 and the pawl 111 are of one-piece design.

The lever 115 and/or the pawl 111 comprise means (118, 119) of securing the lock 100 in the closed position. When the securing means (118, 119) cooperate together, the lock 100 is in the closed and locked position.

In the example, the securing means comprise a hook 118 formed on the lever 115 cooperating with the lug 119 crossing the catch 108 when the lock 100 is in the closed and locked position. The hook 118 is preferably disposed at one end of the lever 115. The hook 118 is capable of catching the lug 119 at the end of a rotation of the lever 115 in the closing direction of the lock 100.

The lever 115 moreover comprises means of detecting a position of the pawl 111. The means of detecting the position of the pawl comprise, for example, a visual marking disposed on the lever 115. In the example, the lever 115 comprises a piece 120 disposed at one end of the lever 115 opposite the hook 118. The piece 120 is intended to bear a button comprising a first marking in one color, green for example, and a second marking in another color, red for example. When the lock 100 is closed and locked, the lever 115 is in a position such that the button reveals the first color marking through an opening made in the panel. In the other lock positions, the lever 115 is in a position such that the button reveals the second color marking through an opening made in the panel. Hence, an observer is able to determine whether the lock 100 is in the closed and locked position or in another position.

In the variant depicted in FIG. 5 and in FIG. 6, the lock 100 comprises an inductive sensor 121 between the walls 101, said sensor being disposed so as to detect a portion of the control lever 115. This portion is, for example, disposed proximate to the end of the lever 115 opposite the hook 118. This portion is, for example, designed as a transverse tongue 122. When the lock 100 is in the closed and locked position, the tongue 122 is disposed opposite the inductive sensor 121 which detects it. The sensor then sends an electric signal used to light up an indicator light in the aircraft's cockpit or on the panel informing the pilot or a ground operator that the lock is in the closed and locked position.

In the example shown in FIG. 5 and in FIG. 6, the control lever 115 moreover comprises a projecting portion 123 disposed proximate to the hook 118. The portion 123 projecting from the lever 115 and the portion of the lever 115 receiving the tongue 122 each comprise a thread capable of being connected to a control linkage. The control linkage is connected to either one or the other of the portions.

The closure of the lock 100 takes place as follows. The lock 100 is in the open position (FIG. 4) and the door of the aircraft is open such that the keeper is at the entrance to the opening 104. The tooth 112 of the pawl 111 cooperates with the portion 1141 of the catch 108. The hook 109 of the catch 108 is guided in the direction of the edges 105 of the walls 101. Then the keeper penetrates the opening 104 through the edges 105. The keeper follows the path 1051 towards the bottom of the opening 104 when the door closes and drives the catch 108 rotationally in the closing direction of the lock 100, being accommodated in the hook 109. The tooth 112 of the pawl 111 slides simultaneously along the portion 1141 of the catch 108 until it reaches the second notch 114, after which it slides along the second notch 114 until it reaches the first notch 113. The tooth 112 of the pawl 111 then engages with the first notch 113 of the catch 108 and the limb 110 of the hook 109 is positioned in such a manner as to lock the keeper against the bottom of the opening 104. The lock 100 is in the closed and unlocked position (FIG. 2). The lever 115 finally pivots under the action of the torsion spring in the closing direction of the lock 100, such that the hook 118 of the lever 115 catches the lug 119 of the catch 108. The lock 100 is then in the closed and locked position.

If, during the closure of the lock 100, the keeper lugs along the path 1051 when the tooth 112 of the pawl 111 slides along the second notch 114, the tooth 112 engages with the second notch 114, leaving the lock 100 in the intermediate position (FIG. 3).

If the keeper sinks too far into the opening 104, the catch 108 continues to pivot in the closing direction, such that the tooth 112 of the pawl 111 does not engage with the first notch 113 of the catch 108, but slides along said catch. The position of the tooth 112 of the pawl 111 relative to the first notch 113 in the catch 108 prevents the hook 118 of the lever 115 from catching the lug 119 of the catch 108, the rotation of the lever 115 and of the pawl 111 about the second axis 103 being linked. Likewise, in the open or intermediate position, the fact that the tooth 112 of the pawl 111 cooperates with the portion 1141 of the catch 108 or is engaged with the second notch 114 in the catch 108 prevents the hook 118 of the lever 115 from catching the lug 119. Hence, the lock 100 cannot be locked without the tooth 112 of the pawl 111 being engaged with the first notch 113. In other words, the lock 100 cannot be unlocked without being in the closed position.

The opening of the lock 100 takes place as follows. From the closed and locked position of the lock 100 (FIG. 1), the control lever 115 is pivoted by an external control about the second axis 103 in the opening direction of the lock 100, such that the hook 118 of the lever 115 is released from the lug 119. When the hook 118 is free from the lug 119 and the tooth 112 of the pawl 111 is engaged with the first notch 113, the lock 100 is in the closed and unlocked position (FIG. 2). The lever 115 then pivots further in the same rotational direction driving the pawl 111 with it in such a manner that the tooth 112 of the pawl 111 disengages from the first notch 113 and the catch 108 is free to pivot in the opening direction of the lock 100. The keeper follows the path 1051 in the direction of the edges 105 of the walls and the hook 109 releases the keeper while pivoting in the opening direction of the lock 100. Finally, the keeper leaves the opening 104, leaving the hook 109 directed towards the edges 105 and the tooth 112 of the pawl 111 cooperating with the portion 1141 of the catch 108. The lock 100 is then in the open position (FIG. 4).

A lock of this kind 100 allows engagement of the tooth 112 of the pawl 111 with the first notch 113 by means of the hook 118 of the lever 115 which catches the lug 119 of the catch 108 to be secured.

1. A lock comprising:
two substantially planar walls bearing a first pivoting link axis and a second pivoting link axis, the first and second axes being substantially perpendicular to the planar walls;
a catch capable of pivoting about the first axis, said catch comprising a hook capable of receiving a keeper;
a pawl capable of pivoting about the second axis, said pawl comprising a tooth capable of engaging with at least one notch formed on the catch;
a control lever capable of pivoting about the second axis, the lever comprising a means for driving the pawl rotationally about the second axis; and
said lock being characterized in that the control lever comprises means for securing closure of the lock, said securing means comprising a hook formed on the control lever and a lug disposed on the catch, substantially parallel to the first axis.

2. The lock as claimed in claim 1, characterized in that the hook cooperates with the lug when the lock is in the closed position.

3. The lock as claimed in claim 2, characterized in that the control lever and the pawl are situated between the planes of the walls.

4. The lock as claimed in claim 1, characterized in that the means of driving the pawl rotationally is a shoulder capable of cooperating with at least one lug formed on the pawl.

5. The lock as claimed in claim 1, characterized in that the control lever and the pawl are configured as one piece.

6. The lock has claimed in claim 1, comprising means for detecting a position of the pawl.

7. The lock as claimed in claim 6, characterized in that the means for detecting the position of the pawl comprise a visual marking disposed at one end of the control lever.

8. The lock has claimed in claim 6, characterized in that the means for detecting the position of the pawl comprise an inductive sensor.

9. The lock as claimed in claim 1, characterized in that the walls additionally bear a third axis and a fourth axis substantially parallel to the first axis, the lock being capable of being fixed to a panel by means of the first, the third and the fourth axes.

10. The lock as claimed in claim 1, characterized in that the control lever and the pawl are situated between the planes of the walls.
